(19) United States
(12) Patent Application Publication
(10) Pub. No.: US 2026/0135979 A1
(43) Pub. Date: May 14, 2026

(54) APPARATUS, SYSTEM, AND METHOD OF SYNCHRONOUS STEREOSCOPIC 3D STREAMING AND VIDEO CONFERENCING

(71) Applicant: Josh Lehman, Las Vegas, NV (US)

(72) Inventor: Josh Lehman, Las Vegas, NV (US)

(21) Appl. No.: 19/355,053

(22) Filed: Oct. 10, 2025

Related U.S. Application Data
(60) Provisional application No. 63/719,363, filed on Nov. 12, 2024.

(51) Int. Cl. H04N 13/111; H04L 65/1089; H04L 65/403; H04N 13/128; H04N 13/194; H04N 13/239; H04N 13/296; H04N 13/344

(52) U.S. Cl. CPC H04N 13/111; H04L 65/1089; H04L 65/403; H04N 13/128; H04N 13/194; H04N 13/239; H04N 13/296; H04N 13/344

(57) ABSTRACT

A system for synchronous stereoscopic 3d streaming and video conferencing comprises a capture device including an imaging system and microphone, a wearable rendering device including two or more screens, and a processing system communicatively connected to at least one of the capture device and the wearable rendering device, comprising a processor and a non-transitory computer-readable medium with instructions stored thereon, which when executed by the processor, perform steps comprising processing captured AV data into 3D stereoscopic frames, compiling the 3D stereoscopic frames into a video, and displaying the video on the wearable rendering device.

### CROSS-REFERENCE TO RELATED APPLICATIONS

This application claims priority to U.S. Provisional Application No. 63/719,363 filed Nov. 12, 2024, incorporated herein by reference in its entirety.

### BACKGROUND

### Field of the Disclosure

The disclosure relates generally to 3D video streaming and video conferencing, and, more particularly, to an apparatus, system, and method of synchronous stereoscopic 3D streaming and/or video conferencing.

### Background of the Disclosure

Traditional video streaming and video conferencing technologies (desktop computers, laptops, televisions, movie theaters, monitors, display screens, and smartphones) provide two-dimensional video capture and rendering. These systems display 2D video on flat displays, utilizing real-time video conferencing protocols such as WebRTC.

Alternative, or virtual, technologies have been one of the fastest developing technologies of the last decade. However, notwithstanding the substantial developments made in this arena, the technology still is very lacking in value in numerous respects. For example, current technology lacks the ability to perform synchronous stereoscopic 3D streaming and/or video conferencing. Thus, there is a need in the art for systems, apparatuses, and methods for synchronous stereoscopic 3D streaming and/or video conferencing.

### SUMMARY OF THE DISCLOSURE

Some embodiments of the invention disclosed herein are set forth below, and any combination of these embodiments (or portions thereof) may be made to define another embodiment.

In one aspect, a system for synchronous stereoscopic 3d streaming and video conferencing comprises a capture device including an imaging system and microphone, a wearable rendering device including two or more screens, and a processing system communicatively connected to at least one of the capture device and the wearable rendering device, comprising a processor and a non-transitory computer-readable medium with instructions stored thereon, which when executed by the processor, perform steps comprising processing captured AV data into 3D stereoscopic frames, compiling the 3D stereoscopic frames into a video, and displaying the video on the wearable rendering device.

In some embodiments, the capture device comprises a sender device, and the wearable rendering device comprises a receiver device.

In some embodiments, the two or more screens are 2D screens.

In some embodiments, ones of the two or more screens are configured to be positioned in front of a user's left eye, and a different ones of the two or more screens are configured to be positioned in front of a user's right eye.

In some embodiments, the wearable rendering device comprises an augmented reality (AR) device, an extended reality (XR) device, or a virtual reality (VR) device.

In some embodiments, the wearable rendering device comprises smart glasses, glasses, contact lenses, or a virtual reality headset.

In some embodiments, the wearable rendering device comprises a plurality of wearable rendering devices.

In some embodiments, the wearable rendering device comprises a speaker.

In some embodiments, the imaging system comprises a dual-camera or stereo camera.

In some embodiments, the imaging system comprises an RGB camera and a LIDAR device.

In some embodiments, the imaging system comprises only a single RGB camera.

In some embodiments, the capture device and wearable rendering device each include a transceiver.

In another aspect, a method for synchronous stereoscopic 3d streaming and video conferencing comprises providing the system described above, capturing audiovisual (AV) data via the capture device, receiving the captured AV data on the wearable rendering device, processing the captured AV data into 3D stereoscopic frames, compiling the 3D stereoscopic frames into a video, and displaying the video on the wearable rendering device.

In some embodiments, the AV data comprises data from a dual-camera or stereo camera.

In some embodiments, the step of processing the captured AV data into 3D stereoscopic frames comprises receiving AV data from left and right cameras of the dual-camera or stereo camera, wherein left and right cameras are synchronized, have equal-sized video frames, stream simultaneously, and are modified to have similar fields of view to generate the 3D experience, and wherein the audio stream is synchronized with the video frames, and combining the video frames from each camera to create the 3D stereoscopic frames.

In some embodiments, the AV data comprises data from an RGB camera and a LIDAR device.

In some embodiments, the step of processing the captured AV data into 3D stereoscopic frames comprises receiving AV data from the RGB camera and depth data from the LIDAR device, shifting each pixel of the AV data based on the corresponding depth data, and concatenating the depth shifted AV data to create the 3D stereoscopic frames.

In some embodiments, the AV data comprises data from only a single RGB camera.

In some embodiments, the step of processing the captured AV data into 3D stereoscopic frames comprises receiving AV data from the RGB camera, estimating a depth for each pixel of the AV data via a machine learning algorithm, shifting each pixel of the AV data based on the corresponding estimated depth, and concatenating the depth shifted AV data to create the 3D stereoscopic frames.

### BRIEF DESCRIPTION OF THE DRAWINGS

The disclosure is illustrated by way of example and not limitation in the accompanying drawings, in which like references may indicate similar elements, and in which:

FIG. 1 is an illustration of aspects of the embodiments relating to synchronous stereoscopic 3D streaming and/or video conferencing;

FIG. 2 is an illustration of aspects of the embodiments showing a screenshot of the disclosed stereoscopic 3D video conference app being rendered on an augmented reality headset while being broadcast from the two back cameras of a smartphone;

FIG. 3 is an illustration of aspects of the embodiments relating to dual-camera synchronous streaming for 3D video streaming and/or video conferencing;

FIG. 4 is an illustration of aspects of the embodiments relating to LIDAR based monocular to stereoscopic conversion for synchronous video streaming and/or video conferencing;

FIG. 5 is an illustration of aspects of the embodiments relating to AI-driven monocular to stereoscopic conversion which utilizes deep learning for depth estimation from RGB to grayscale depth maps for synchronous video streaming and/or video conferencing;

FIG. 6 is an illustration of aspects of the embodiments relating to a stereoscopic rendering shader on an augmented reality headset; and

FIG. 7 is an illustration of a computing device in which aspects of the embodiments may be practiced.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical similar devices, systems, and methods. Those of ordinary skill may recognize that other elements and/or operations may be desirable and/or necessary to implement the devices, systems, and methods described herein. But because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

The terminology used herein is for the purpose of describing particular example embodiments only and is not intended to be limiting. For example, as used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc., may be used herein to describe various elements, components, regions, layers and/or sections, these elements, components, regions, layers and/or sections should not be limited by these terms. These terms may be only used to distinguish one element, component, region, layer or section from another element, component, region, layer or section. That is, terms such as “first,” “second,” and other numerical terms, when used herein, do not imply a sequence or order unless clearly indicated by the context. Thus, a first element, component, region, layer or section discussed below could be termed a second element, component, region, layer or section without departing from the teachings of the exemplary embodiments.

Processor-implemented modules, systems and methods of use are disclosed herein that may provide access to and transformation of a plurality of types of digital content, including but not limited to video, image, text, audio, metadata, algorithms, interactive and document content, and which track, deliver, manipulate, transform, transceive and report the accessed content. Described embodiments of these modules, systems and methods are intended to be exemplary and not limiting. As such, it is contemplated that the herein described systems and methods may be adapted and may be extended to provide enhancements and/or additions to the exemplary modules, systems and methods described. The disclosure is thus intended to include all such extensions.

Disclosed herein are embodiments for a real-time synchronous 3D video streaming or conference can combine one or more devices sending and receiving audio and video streams simultaneously. The following describes technical approaches to generate and render 3D Videos to and from the sender and receiver device.

In some embodiments, stereoscopic 3D video conferencing introduces three-dimensional video rendering, displayable on standard 2D screens and augmented reality (AR) devices (smart glasses, glasses, contact lenses, and virtual reality headsets). For AR, extended reality (XR), and virtual reality (VR) devices, or any device capable of rendering a 2D or 3D display, the left channel of the stereoscopic 3D video is rendered to the user's left eye, and the right channel to the right eye. This separation creates a compelling three-dimensional effect for the user.

In some embodiments, integrating video conferencing protocols like WebRTC enables real-time, bidirectional communication among two or more participants simultaneously. Video capture can be done with any mono or stereo camera setup (smartphone cameras, webcams, laptop cameras).

In some embodiments, the technical processes can be performed on a server and/or locally on the device. In some embodiments, to achieve the real-time communication needed for video conferencing, all processes are performed locally on the capture and rendering devices, thus eliminating the need for a server and minimizing delays. In some embodiments, processing occurs directly on the devices, and audio and video data are sent via a video conferencing protocol such as WebRTC or similar.

In some embodiments, a system 100 for synchronous stereoscopic 3d streaming and video conferencing comprises a capture device 101 including an imaging system and microphone, a wearable rendering device 102 including two or more screens, and a processing system communicatively connected to at least one of the capture device 101 and the wearable rendering device 102. In some embodiments, the processing system comprises a processor and a non-transitory computer-readable medium with instructions stored thereon, which when executed by the processor, perform steps comprising processing captured AV data into 3D stereoscopic frames 103, compiling the 3D stereoscopic frames into a video 104, and displaying the video on the wearable rendering device.

In some embodiments, the capture device 101 comprises a sender device, and the wearable rendering device 102 comprises a receiver device. In some embodiments, the two or more screens are 2D screens. In some embodiments, ones of the two or more screens are configured to be positioned in front of a user's left eye, and a different ones of the two or more screens are configured to be positioned in front of a user's right eye.

In some embodiments, the wearable rendering device 102 comprises an augmented reality (AR) device, an extended reality (XR) device, or a virtual reality (VR) device. In some embodiments, the wearable rendering device 102 comprises smart glasses, glasses, contact lenses, or a virtual reality headset. In some embodiments, the wearable rendering device 102 comprises a plurality of wearable rendering devices. In some embodiments, the wearable rendering device 102 comprises a speaker.

In some embodiments, the imaging system comprises a dual-camera or stereo camera. In some embodiments, the imaging system comprises an RGB camera and a LIDAR device. In some embodiments, the imaging system comprises only a single RGB camera. In some embodiments, the capture device 101 and wearable rendering device 102 each include a transceiver.

In another aspect, a method for synchronous stereoscopic 3d streaming and video conferencing comprises providing the system 100, capturing audiovisual (AV) data via the capture device 101, receiving the captured AV data on the wearable rendering device 102, processing the captured AV data into 3D stereoscopic frames 103, compiling the 3D stereoscopic frames into a video 104, and displaying the video on the wearable rendering device.

In some embodiments, the AV data comprises data from a dual-camera or stereo camera. In some embodiments, the step of processing the captured AV data into 3D stereoscopic frames comprises receiving AV data from left and right cameras of the dual-camera or stereo camera, wherein left and right cameras are synchronized, have equal-sized video frames, stream simultaneously, and are modified to have similar fields of view to generate the 3D experience, and wherein the audio stream is synchronized with the video frames, and combining the video frames from each camera to create the 3D stereoscopic frames.

In some embodiments, the AV data comprises data from an RGB camera and a LIDAR device. In some embodiments, the step of processing the captured AV data into 3D stereoscopic frames comprises receiving AV data from the RGB camera and depth data from the LIDAR device, shifting each pixel of the AV data based on the corresponding depth data, and concatenating the depth shifted AV data to create the 3D stereoscopic frames.

In some embodiments, the AV data comprises data from only a single RGB camera. In some embodiments, the step of processing the captured AV data into 3D stereoscopic frames comprises receiving AV data from the RGB camera, estimating a depth for each pixel of the AV data via a machine learning algorithm, shifting each pixel of the AV data based on the corresponding estimated depth, and concatenating the depth shifted AV data to create the 3D stereoscopic frames.

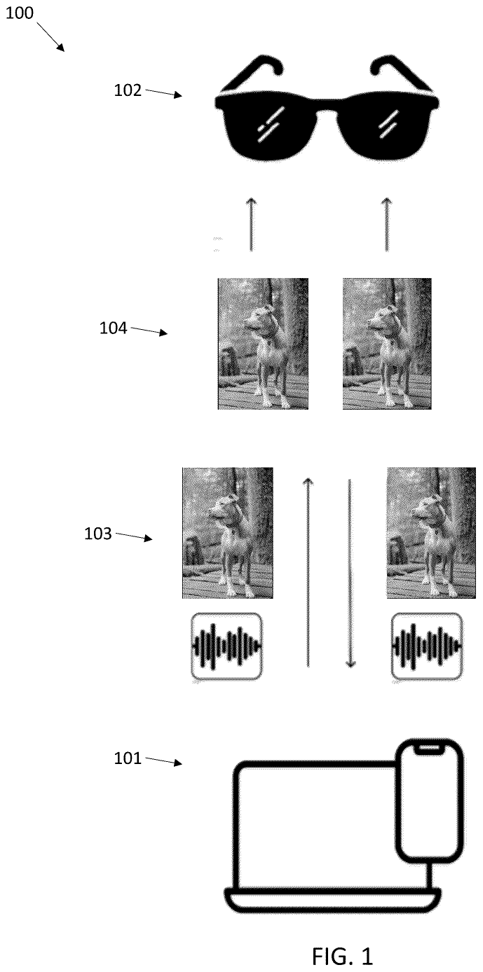

FIG. 1 illustrates aspects of the embodiments relating to synchronous stereoscopic 3D streaming and/or video conferencing pipeline. With any camera, laptop, webcam, smartphone, and/or computer it is possible to stream an interactive synchronous 3D video chat for two-way or larger communication.

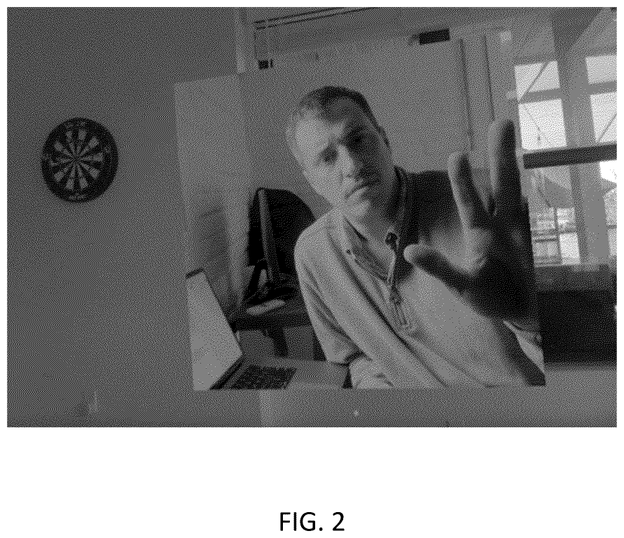

FIG. 2 illustrates aspects of the embodiments showing a screenshot of the disclosed stereoscopic 3D video conference app being rendered on an augmented reality headset while being broadcast from the two back cameras of a smartphone.

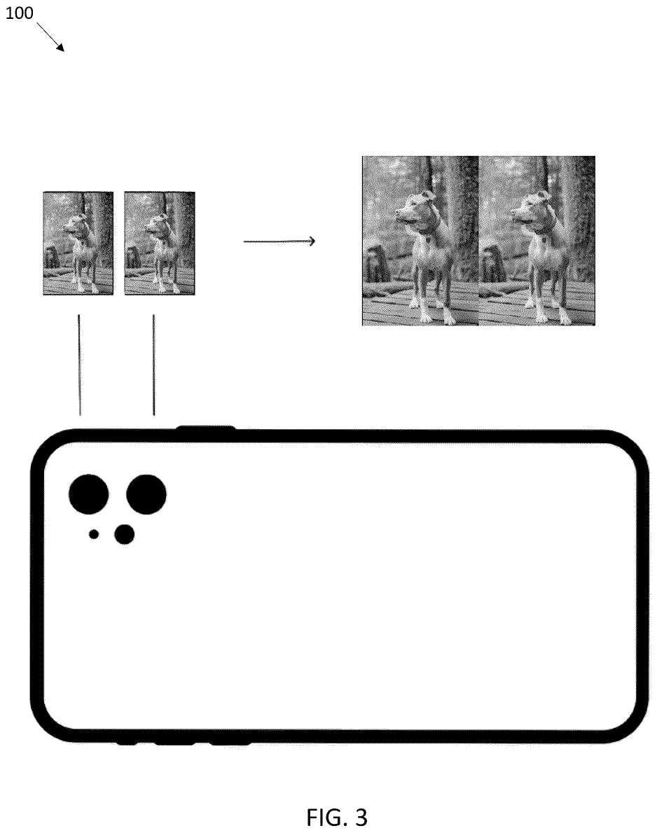

FIG. 3 illustrates aspects of the embodiments relating to dual-camera synchronous streaming for 3D video streaming and/or video conferencing. Utilizing any 3D stereo camera set up and/or utilizing two or more back or front facing cameras of a smartphone it is possible to capture video from two separate lenses and then combine each frame to create a 3D stereoscopic view.

In some embodiments, the sender (smartphone with two lenses, computer connected to a stereoscopic camera, or any device capable of capturing stereoscopic content and audio) uses two cameras. The left and right cameras are “genlocked” (synchronized), have equal-sized frames, stream simultaneously, and are modified to have similar fields of view to generate the 3D experience. The audio stream is synchronized with the video frames. Frames from each camera are combined to create a stereoscopic video frame sent to one or more receivers. Receivers get the left camera content to their left eye and the right camera content to their right eye. Video frames and audio are sent using a real-time communication protocol such as WebRTC.

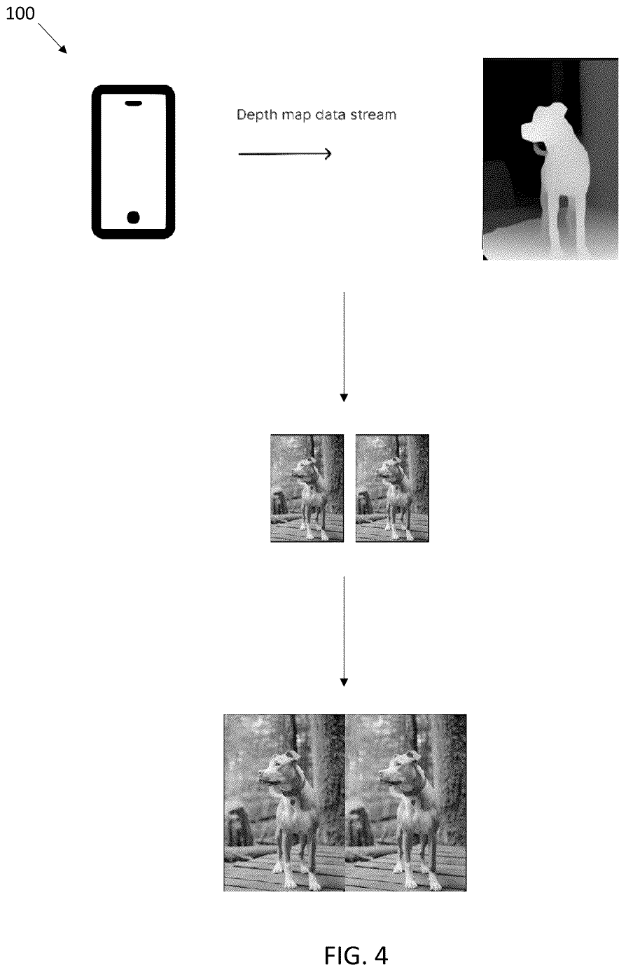

FIG. 4 illustrates aspects of the embodiments relating to LIDAR based monocular to stereoscopic conversion for synchronous video streaming and/or video conferencing. Using a deep learning model one can input a single RGB frame and output an estimated depth map grayscale image. Creating two images with offset binocular disparity on the x-axis can be used to create a stereoscopic 3D effect. Photos can then be concatenated to create a stereoscopic frame. Frames are then compiled to create a video which may be sent through a streaming or video conferencing protocol.

In some embodiments, the sender (smartphone or computer combining lidar technology with an RGB camera, or any device capable of capturing and processing RGB frames and their corresponding depth information, and capturing audio) generates a stereoscopic image from a single frame using horizontal parallax (x-axis offset). The LIDAR sensor provides depth data combined with the RGB image to generate a realistic stereoscopic image. Techniques include shifting each pixel based on its depth or using a machine learning model that inputs the image and depth map to return a stereoscopic image. Two images (left and right offsets) are generated from the depth data and combined into a single stereoscopic image. This image and the audio data are sent via a video conferencing protocol such as WebRTC.

In some embodiments, generation of the left and right stereoscopic images from the RGB and LiDAR data is performed by applying pixel-wise horizontal disparity based on the measured depth. For example, let I(x,y) denote the RGB image captured by the camera, and D(x,y) denote the per-pixel depth values provided by the LiDAR sensor. Given the effective focal length (f) (in pixels) and the inter-ocular baseline (B) (in meters or millimeters), a horizontal disparity value δ(x,y) can be computed for each pixel as: δ(x,y)=f×B/D(x,y). Each pixel of the RGB frame is then shifted horizontally according to its disparity: I_{L(x,y)}=I(x+½ δ(x,y),y) and I_{R(x,y)}=I(x−½δ(x,y),y).

Sub-pixel interpolation (bilinear or bicubic) may be applied to ensure smooth results. The two resulting images (I_{L}) and (I_{R}) represent the left-eye and right-eye views, respectively, and are concatenated side-by-side or encoded in a stereo video frame (e.g., top-bottom or interleaved format).

Optional post-processing may include bilateral filtering of the depth map to remove noise, hole-filling of occluded regions, and tone matching between the left and right frames. The resulting stereoscopic image is then encoded together with synchronized audio for real-time transmission via WebRTC.

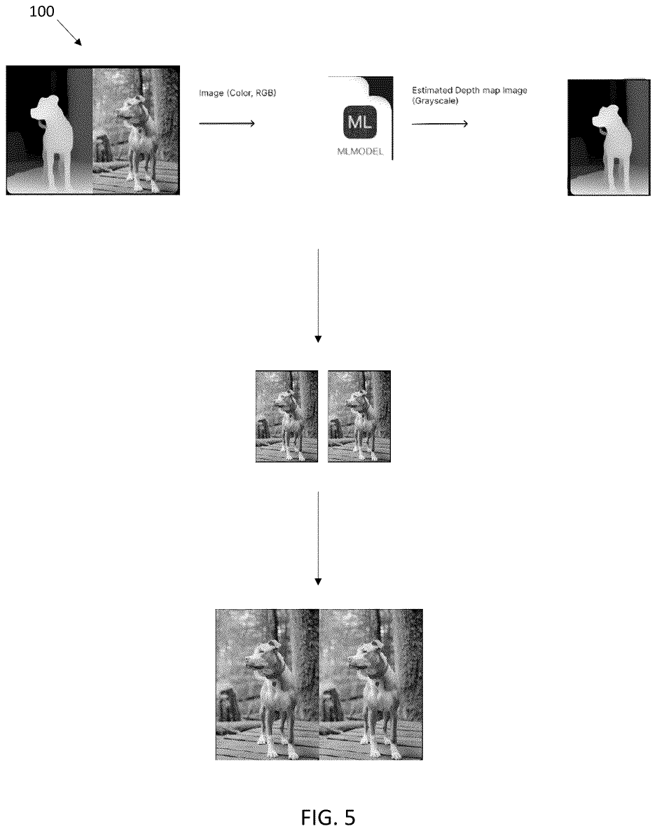

FIG. 5 illustrates aspects of the embodiments relating to AI-driven monocular to stereoscopic conversion which utilizes deep learning for depth estimation from RGB to grayscale depth maps for synchronous video streaming and/or video conferencing. Using a deep learning model once can input a single RGB frame and output an estimated depth map grayscale image. Creating two images with offset binocular disparity on the x-axis can be used to create a stereoscopic 3D effect. Photos can then be concatenated to create a stereoscopic frame. Frames are then compiled to create a video which may be sent through a streaming or video conferencing protocol.

In some embodiments, the sender (smartphone or computer with an RGB camera, capable of capturing and processing RGB frames and audio) uses a deep learning model for depth estimation to generate a grayscale depth map from an RGB input image. Similar to the method of FIG. 4, a stereoscopic image is generated from this depth map, and sent with the audio data via a video conferencing protocol such as WebRTC.

In some embodiments, when no depth sensor is available, the system employs a machine learning model trained to infer depth from monocular RGB input. The model, for example, a convolutional neural network or transformer-based depth-estimation network, outputs an estimated depth map D_{hat(x,y)} from the input RGB frame I(x,y). The stereoscopic image generation then proceeds analogously to the above LiDAR embodiment, substituting the estimated depth map for the measured one. For each pixel: δ(x,y)=f×B/D_{hat(x,y)}, and the left/right images are generated as: I(x,y)=I(x+½δ(x,y),y) and I_{R(x,y)}=I(x−½δ(x,y),y).

In some embodiments, the machine learning model may directly output a disparity or offset map instead of depth, thereby bypassing the above computation. The resulting stereo frame is combined with synchronized audio and transmitted via a real-time protocol such as WebRTC.

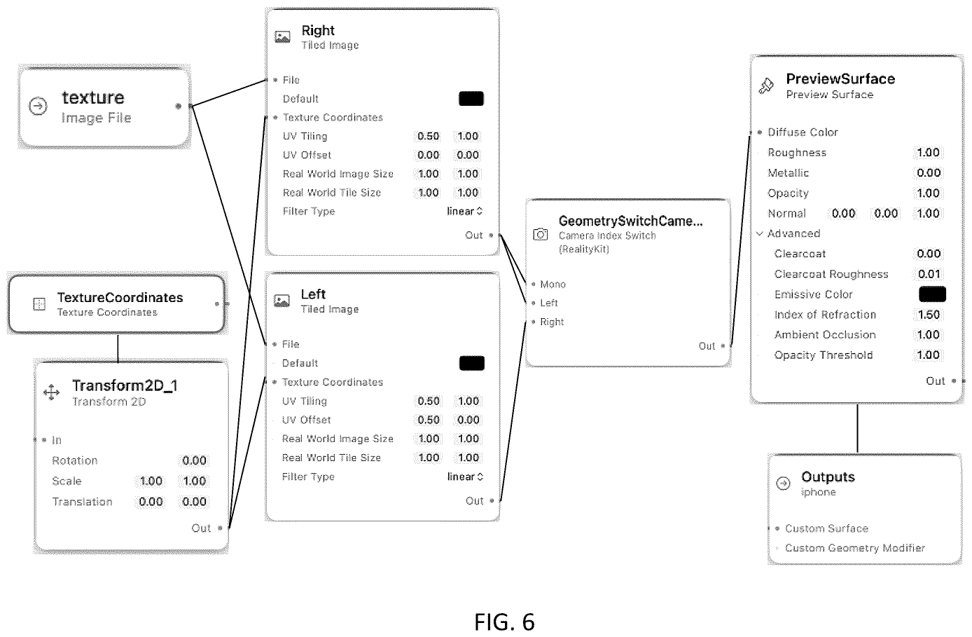

FIG. 6 illustrates aspects of the embodiments relating to a stereoscopic rendering shader on an augmented reality headset. In some embodiments, the receiver (native app or browser, optionally running in an AR/VR environment using APIs such as WebXR) receives the audio and video stream. The stereoscopic frame is converted into two images (one for each eye). Techniques such as shaders (e.g., for Apple Vision Pro) can be used to deliver the content to the corresponding eye. The audio is synchronized with the video, creating a real-time synchronous 3D video conferencing experience. FIG. 6 illustrates a Shader written for an augmented reality device to split the frame and deliver the content to the corresponding eye.

The ability to stream real-time synchronous stereoscopic video conferences represents a significant advancement in communication technology. With the continued development and proliferation of devices capable of rendering 3D content, such as advanced AR/VR headsets and glasses, the importance and prevalence of this technology will likely increase substantially, enabling richer and more immersive real-time interactions across diverse applications.

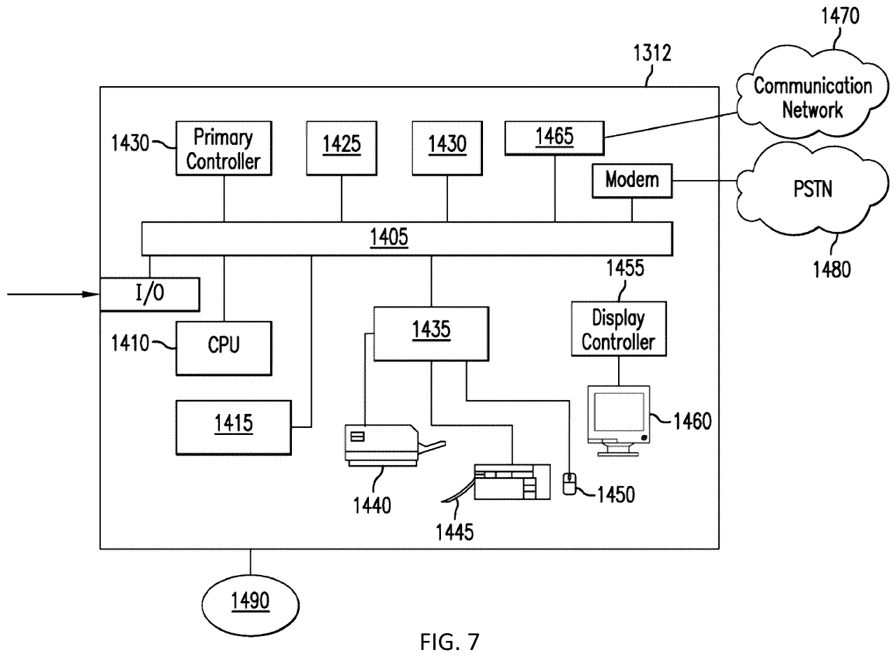

FIG. 7 depicts an exemplary computer processing system 1312 for use in association with the embodiments, by way of non-limiting example. Processing system 1312 is capable of executing software, such as an operating system (OS), applications, user interface, and/or one or more other computing algorithms/applications 1490, such as the recipes, models, programs and subprograms discussed herein. The operation of exemplary processing system 1312 is controlled primarily by these computer readable instructions/code 1490, such as instructions stored in a computer readable storage medium, such as hard disk drive (HDD) 1415, optical disk (not shown) such as a CD or DVD, solid state drive (not shown) such as a USB “thumb drive,” or the like. Such instructions may be executed within central processing unit (CPU) 1410 to cause system 1312 to perform the disclosed operations, comparisons and calculations. In many known computer servers, workstations, personal computers, and the like, CPU 1410 is implemented in an integrated circuit called a processor.

It is appreciated that, although exemplary processing system 1312 is shown to comprise a single CPU 1410, such description is merely illustrative, as processing system 1312 may comprise a plurality of CPUs 1410. Additionally, system 1312 may exploit the resources of remote CPUs (not shown) through communications network 1470 or some other data communications means 1480, as discussed throughout.

In operation, CPU 1410 fetches, decodes, and executes instructions from a computer readable storage medium, such as HDD 1415. Such instructions may be included in software 1490. Information, such as computer instructions and other computer readable data, is transferred between components of system 1312 via the system's main data-transfer path. The main data-transfer path may use a system bus architecture 1405, although other computer architectures (not shown) can be used.

Memory devices coupled to system bus 1405 may include random access memory (RAM) 1425 and/or read only memory (ROM) 1430, by way of example. Such memories include circuitry that allows information to be stored and retrieved. ROMs 1430 generally contain stored data that cannot be modified. Data stored in RAM 1425 can be read or changed by CPU 1410 or other hardware devices. Access to RAM 1425 and/or ROM 1430 may be controlled by memory controller 1420.

In addition, processing system 1312 may contain peripheral communications controller and bus 1435, which is responsible for communicating instructions from CPU 1410 to, and/or receiving data from, peripherals, such as peripherals 1440, 1445, and 1450, which may include printers, keyboards, and/or the operator interaction elements on a mobile device as discussed herein throughout. An example of a peripheral bus is the Peripheral Component Interconnect (PCI) bus that is well known in the pertinent art.

Operator display 1460, which is controlled by display controller 1455, may be used to display visual output and/or presentation data generated by or at the request of processing system 1312, such as responsive to operation of the aforementioned computing programs/applications 1490. Such visual output may include text, graphics, animated graphics, and/or video, for example. Display 1460 may be implemented with a CRT-based video display, an LCD or LED-based display, a gas plasma-based flat-panel display, a touch-panel display, or the like. Display controller 1455 includes electronic components required to generate a video signal that is sent to display 1460.

Further, processing system 1312 may contain network adapter 1465 which may be used to couple to external communication network 1470, which may include or provide access to the Internet, an intranet, an extranet, a ledger, a public ledger, a blockchain, or the like. Communications network 1470 may provide access for processing system 1312 with means of communicating and transferring software and information electronically. Additionally, communications network 1470 may provide for distributed processing, which involves several computers and the sharing of workloads or cooperative efforts in performing a task, as discussed above. Network adaptor 1465 may communicate to and from network 1470 using any available wired or wireless technologies. Such technologies may include, by way of non-limiting example, cellular, Wi-Fi, Bluetooth, infrared, or the like.

Aspects of the invention relate to machine learning and artificial intelligence executed on a computing device, wherein the computing device may be processing system 1312. In some embodiments, the disclosed systems and methods utilize machine learning algorithms and models, including one or more neural networks, that may operate on at least one computing device (e.g., processing system 1312). The disclosed system may employ various types of neural networks known in the art, including but not limited to feedforward neural networks (FNNs), convolutional neural networks (CNNs), recurrent neural networks (RNNs), transformer networks, autoencoders, generative adversarial networks (GANs), Radial Basis Function Networks (RBFNs), extreme learning machines (ELMs), quantum neural networks (QNNs), and deep neural networks (DNNs).

Machine learning is a branch of artificial intelligence (AI) that enables systems to learn and improve from experience without being explicitly programmed. Machine learning models analyze data sets to identify patterns and correlations, and then uses those patterns to make predictions or decisions. Machine learning models can generally be categorized into three primary types: supervised learning, unsupervised learning, and semi-supervised learning.

Supervised learning involves training a model using labeled datasets to classify data or predict outcomes accurately. As input data is fed into the model, the model adjusts its internal parameters (e.g., weights) to minimize prediction errors. Common methods used in supervised learning include neural networks, naïve Bayes classifiers, linear regression, logistic regression, random forests, and support vector machines (SVMs).

Classification is a common task in supervised learning, where data inputs are categorized into distinct classes. Classification models may include binary classifiers (e.g., spam vs. non-spam) and multi-class classifiers (e.g., identifying different species of animals). A decision tree is a widely used classification method that applies a sequence of “if-then” conditions to narrow down possible outcomes.

Regression is another form of supervised learning where the output is a continuous variable rather than a discrete category. Linear regression predicts a continuous value based on a linear relationship between inputs and outputs, while logistic regression predicts categorical outcomes based on defined inputs.

Unsupervised learning involves analyzing unlabeled datasets to identify hidden patterns or groupings without human intervention. Principal component analysis (PCA) and singular value decomposition (SVD) are common techniques used to reduce data dimensionality and reveal underlying structures.

Clustering is a key unsupervised learning technique where data points are grouped based on shared features or proximity. K-means clustering is a widely used method where the number of clusters is defined by a variable “k,” and the algorithm iteratively adjusts cluster centroids to minimize variance within each cluster. Other clustering methods include hierarchical clustering and probabilistic clustering.

Semi-supervised learning combines elements of both supervised and unsupervised learning. A model is initially trained using a smaller labeled dataset, which then guides the classification and feature extraction from a larger unlabeled dataset. Semi-supervised learning is particularly useful when acquiring large amounts of labeled data is costly or impractical.

Multi-modal sensing machine learning involves combining data from multiple sensors (like cameras, microphones, and radar) to create a more complete and accurate understanding of the environment. This approach leverages the strengths of different sensors, allowing machines to “see” and “hear” the world in a way that's more like human perception, and improves the performance of machine learning models in tasks like object recognition, scene understanding, robot navigation.

Deep learning is a subfield of machine learning that uses neural networks with multiple hidden layers to process and analyze complex data. Neural networks mimic the structure and function of the human brain, comprising layers of interconnected nodes (neurons). Each neuron receives input data, applies a transformation based on assigned weights, and passes the result to the next layer.

A typical neural network may include: input layer-receives raw data inputs; hidden layer(s)—applies mathematical transformations using weighted connections; and output layer—generates the final prediction or classification.

Convolutional neural networks (CNNs) are a type of neural network particularly well-suited for processing image and spatial data. CNNs use convolutional layers to extract spatial features from input data, pooling layers to reduce dimensionality, and fully connected layers to generate output predictions.

Deep neural networks (DNNs) are composed of multiple hidden layers and are capable of learning complex patterns in large datasets. Recurrent neural networks (RNNs) are a type of deep learning network designed for sequential data, such as time series or natural language, where previous inputs influence future outputs. Long short-term memory (LSTM) networks are a specialized form of RNN that mitigates issues with long-term dependencies.

Generative Adversarial Networks (GANs) are a class of machine learning models in which two neural networks—a generator and a discriminator—are trained together in a competitive framework. The generator creates synthetic data (e.g., images, audio) from random noise, while the discriminator evaluates whether the generated data is real or fake. The generator improves its output by trying to fool the discriminator, while the discriminator becomes better at distinguishing real data from generated data. This adversarial process drives both networks to improve over time, leading to the generation of highly realistic data.

Types of GANs include: Vanilla GAN—The original GAN model, where the generator and discriminator are trained using a minimax loss function. Deep Convolutional GAN (DCGAN)—Uses convolutional layers instead of fully connected layers, improving the quality of generated images. Conditional GAN (cGAN)—Conditions the generation process on class labels or other input data, enabling targeted generation (e.g., generating images of specific objects). Wasserstein GAN (WGAN)—Introduces the Wasserstein distance (Earth Mover's distance) as the loss function, which improves training stability and reduces mode collapse (when the generator produces limited variations of data). WGAN-GP (Wasserstein GAN with Gradient Penalty)—Improves WGAN by adding a gradient penalty to enforce the Lipschitz constraint, further enhancing training stability. CycleGAN—Used for unpaired image-to-image translation (e.g., converting paintings to photos) by enforcing consistency between the forward and backward transformations. StyleGAN—Generates high-resolution and highly detailed images using a style-based generator architecture, allowing greater control over features like face shape and texture. GANs are widely used in fields such as computer vision, natural language processing, and creative design, but they can be difficult to train due to instability and mode collapse—challenges that models like WGAN and WGAN-GP address effectively.

In some embodiments, the disclosed system may include an AI model trained using reinforcement learning, where an agent learns to make decisions through trial and error by interacting with an environment and receiving feedback in the form of rewards or penalties.

In the foregoing Detailed Description, it can be seen that various features are grouped together in a single embodiment for the purpose of clarity and brevity of the disclosure. This method of disclosure is not to be interpreted as reflecting an intention that the embodiments require more features than are expressly recited herein. Rather, the disclosure is to encompass all variations and modifications to the disclosed embodiments that would be understood to the skilled artisan in light of the disclosure.

What is claimed is:

1. A system for synchronous stereoscopic 3d streaming and video conferencing, comprising:
a capture device including an imaging system and microphone;
a wearable rendering device including two or more screens; and
a processing system communicatively connected to at least one of the capture device and the wearable rendering device, comprising a processor and a non-transitory computer-readable medium with instructions stored thereon, which when executed by the processor, perform steps comprising:
processing captured AV data into 3D stereoscopic frames;
compiling the 3D stereoscopic frames into a video; and
displaying the video on the wearable rendering device.

2. The system of claim 1, wherein the capture device comprises a sender device, and the wearable rendering device comprises a receiver device.

3. The system of claim 1, wherein the two or more screens are 2D screens.

4. The system of claim 1, wherein ones of the two or more screens are configured to be positioned in front of a user's left eye, and a different ones of the two or more screens are configured to be positioned in front of a user's right eye.

5. The system of claim 1, wherein the wearable rendering device comprises an augmented reality (AR) device, an extended reality (XR) device, or a virtual reality (VR) device.

6. The system of claim 1, wherein the wearable rendering device comprises smart glasses, glasses, contact lenses, or a virtual reality headset.

7. The system of claim 1, wherein the wearable rendering device comprises a plurality of wearable rendering devices.

8. The system of claim 1, wherein the wearable rendering device comprises a speaker.

9. The system of claim 1, wherein the imaging system comprises a dual-camera or stereo camera.

10. The system of claim 1, wherein the imaging system comprises an RGB camera and a LIDAR device.

11. The system of claim 1, wherein the imaging system comprises only a single RGB camera.

12. The system of claim 1, wherein the capture device and wearable rendering device each include a transceiver.

13. A method for synchronous stereoscopic 3d streaming and video conferencing, comprising:
providing the system of claim 1;
capturing audiovisual (AV) data via the capture device;
receiving the captured AV data on the wearable rendering device;
processing the captured AV data into 3D stereoscopic frames;
compiling the 3D stereoscopic frames into a video; and
displaying the video on the wearable rendering device.

14. The method of claim 13, wherein the AV data comprises data from a dual-camera or stereo camera.

15. The method of claim 14, wherein the step of processing the captured AV data into 3D stereoscopic frames comprises:
receiving AV data from left and right cameras of the dual-camera or stereo camera, wherein left and right cameras are synchronized, have equal-sized video frames, stream simultaneously, and are modified to have similar fields of view to generate the 3D experience, and wherein the audio stream is synchronized with the video frames; and
combining the video frames from each camera to create the 3D stereoscopic frames.

16. The method of claim 13, wherein the AV data comprises data from an RGB camera and a LIDAR device.

17. The method of claim 16, wherein the step of processing the captured AV data into 3D stereoscopic frames comprises:
receiving AV data from the RGB camera and depth data from the LIDAR device;
shifting each pixel of the AV data based on the corresponding depth data; and
concatenating the depth shifted AV data to create the 3D stereoscopic frames.

18. The method of claim 13, wherein the AV data comprises data from only a single RGB camera.

19. The method of claim 18, wherein the step of processing the captured AV data into 3D stereoscopic frames comprises:
receiving AV data from the RGB camera;
estimating a depth for each pixel of the AV data via a machine learning algorithm;
shifting each pixel of the AV data based on the corresponding estimated depth; and
concatenating the depth shifted AV data to create the 3D stereoscopic frames.
